(19) United States
(12) Patent Application Publication
(10) Pub. No.: US 2010/0007463 A1
(43) Pub. Date: Jan. 14, 2010

(54) VEHICLE HANDLE WITH CONTROL CIRCUITRY

(75) Inventors: David A. Dingman, Grand Haven, MI (US); Brett A. Gorby, Grand Rapids, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MAGNA MIRRORS OF AMERICA, INC., Holland, MI (US)

(21) Appl. No.: 12/499,183

(22) Filed: Jul. 8, 2009

Related U.S. Application Data
(60) Provisional application No. 61/084,664, filed on Jul. 30, 2008.
(60) Provisional application No. 61/079,231, filed on Jul. 9, 2008.

(51) Int. Cl. G05B 19/00; B60R 25/00; G06F 7/04; B60Q 1/00

(52) U.S. Cl. 340/5.72; 340/425.5

(57) ABSTRACT

A handle/liftgate assembly for a door of a vehicle is mounted to a handle region of a vehicle door and includes a handle control and a handle sensor. The handle control is responsive to the handle sensor to detect the presence of or proximity of a user or operator at the vehicle door. The handle control actuates a door latch of the vehicle door to open the vehicle door independent of a door zone module or passive entry system of the vehicle door.

### CROSS REFERENCE TO RELATED APPLICATIONS

The present application claims the benefit of U.S. provisional applications, Ser. No. 61/084,664, filed Jul. 30, 2008; and Ser. No. 61/079,231, filed Jul. 9, 2008, which are hereby incorporated herein by reference in their entireties.

### FIELD OF THE INVENTION

The present invention relates to handles for vehicles and, more particularly, to an exterior handle for opening a side door and/or liftgate of a vehicle or interior handle for opening a side door and/or liftgate of a vehicle.

### BACKGROUND OF THE INVENTION

Typically, a vehicle door includes a door zone module and/or passive entry system (such as at or in the armrest of a vehicle door), which is in communication with a body control module of the vehicle and with the separate and remote switches of the door handle. The door zone module or passive entry system is operable to fire or actuate the door latch in response to the switches and/or sensors at the door handle and in response to the body control module. For example, the door zone module or passive entry system may fire or actuate the door latch in response to the appropriate signals from the door handle switches, but the latch will not open unless an authenticating signal or unlocking signal is received from the body control module, which communicates such an unlocking signal in response to a communication from the door zone module or passive entry system and after confirmation that the person at the door is recognized (such as by recognizing a key fob carried by the person) and/or that the vehicle is not moving or is in park.

The remotely located door zone module or passive entry system (located remote from the door handle and its sensors or microswitches) typically continuously checks or monitors the handle switches. The first microswitch tells the door zone module or passive entry system that the handle is being pulled, whereby the door zone module or passive entry system tells the body control module or passive entry system to wake up and initiate the passive entry function. The body control module or passive entry system looks at the vehicle antenna or antennae for authentication (such as for identifying-that the person pulling at the door handle is carrying the corresponding or recognized transmitting device or the like) and, if authentication is verified, the body control module or passive entry system tells the latch to unlatch and/or unlock. The second microswitch (if the handle is pulled further) tells the door zone module or passive entry system that the handle has been pulled further to the open position, whereby the door zone module or passive entry system tells the latch to unlatch and/or unlock to open the vehicle door. Thus, the body control module signal and the door zone module or passive entry system signal cooperate to open the vehicle door in response to a user pulling at the handle or activating capacitive/electronic entry. Alternative system may only use a single microswitch that sends both the unlock and unlatch signals to the latch. Alternative design may also use multiple microswitches that send multiple other signals.

A typical door zone module or passive entry system thus is disposed within the vehicle and is configured to communicate between the remotely located body control module and the remotely located door handle sensor elements. Thus, an additional connection and complicated circuitry and/or compatibility requirements may be required to provide the communications with the sensors or body control module and to provide the control of the door latch. Such door zone module or passive entry systems thus may experience problems in the field due to the additional level of connections and/or communications and the compatibility or lack thereof with different door handles and with other components of the vehicle door (which may be provided by different suppliers or vendors). Also, due to the multiple components controlled by the door zone module or passive entry system, there may be difficulties in effectively diagnosing problems and thus any fault code or diagnosis may target the wrong component, which may lead to an increase in warranty problems for the vehicle. Also, if one of the handle switches fails, a user cannot enter the vehicle without using his or her key to manually unlock the vehicle door latch.

### SUMMARY OF THE INVENTION

The present invention provides an exterior handle assembly for opening a door/liftgate of a vehicle that includes a microprocessor or control or control circuitry that is operable to communicate with the vehicle or body control module to open the door of the vehicle responsive to an antenna and/or electronic switch or microswitch and/or a passive entry system and independent of a door zone module or passive entry system of the vehicle door.

According to an aspect of the present invention, a handle assembly for opening a door/liftgate of a vehicle includes a door handle control and a handle sensor. The door handle control is responsive to the sensor to detect the presence of or proximity of a user or operator at the vehicle door (such as capacitive sensing or by detecting movement of a handle portion or the presence of a passive entry device or transmitting device or the like carried by the user). The door handle control actuates the door latch to open the vehicle door independent of a door zone module or passive entry system of the vehicle door.

The door handle control may, upon detection of the presence of or proximity of the user or operator at the vehicle door, communicate a signal to the vehicle or body control module, which may determine (such as via a passive entry system of the vehicle) whether or not the person at the vehicle door is recognized or authorized for entry into the vehicle (by detecting a passive entry device or transmitting device or key fob carried by the person). The body control module or passive entry system may then authenticate the detection of the presence of or proximity of the user by the door handle control and may unlock the door latch, whereby the door handle control may send a signal to the latch to open the vehicle door (such as in response to actuation of a switch or sensor at the door handle) upon authentication from the body control module or passive entry system.

Optionally, the handle assembly may comprise a base portion mountable to the vehicle door and a handle portion (such as a pull strap portion or a paddle portion or the like) that is movably or pivotally mountable to the vehicle door. Optionally, the handle may comprise a fixed handle assembly having a fixed handle portion that is fixedly mountable to the vehicle door. The door handle control may be responsive to an antenna and/or capacitive sensor and/or one or more microswitches (that may detect movement of the handle portion by a person at the vehicle door) and/or a passive entry system. The handle control thus may send a signal to actuate the latch device in response to the antenna and/or capacitive sensor and/or microswitches and/or passive entry system of the vehicle, whereby the latch device may be fired or actuated to open the front and/or rear doors and/or liftgate in response to the handle control and further in response to an authentication or unlock signal from the vehicle or body control module or passive entry system.

Therefore, the present invention provides a handle assembly or module that is a self-contained or self-sufficient or independently operable unit and that has a door handle control or control circuitry incorporated therein. The handle assembly thus may directly communicate with door handle sensors or antenna and may communicate with the body control module of the vehicle, without requiring communication with the door zone module within the vehicle door. The present invention thus provides a handle assembly or module that achieves enhanced performance in opening the vehicle door or liftgate and reduces communication and/or compatibility concerns present in conventional systems having a separate door zone module or passive entry system that communicates with the door handle sensors and with the body control module of the vehicle. The circuitry within the door handle controller or passive entry system has the ability to self-diagnose system failures or current states within the door handle controller and passive entry system and other components. The door handle controller may function to send or communicate such information back to the vehicle diagnostics system.

Optionally, the present invention may provide a door handle assembly that is generally flush with the outer or exterior surface of the exterior panel of a vehicle door. The door handle may include a handle portion and a cover element that cooperate to provide a generally flush, closed appearance of the door handle when not in use, with the cover element being movable by a user so that the user can access the handle portion to move the handle portion to open the vehicle door.

For example, and according to an aspect of the invention, a door handle assembly for a door of a vehicle is mounted at a handle region of a vehicle door and includes a base portion mountable to the vehicle door, a handle portion movably mounted to the base portion, and a cover element. The handle portion is movable from an initial position to an opening position to actuate a latch mechanism of the vehicle door to open the vehicle door. The handle portion has a handle outer surface. The cover element is movably mounted to the base portion and movable from an initial position to an access position to facilitate access to the handle portion when the handle portion is in the initial position. The cover element has a cover outer surface. The handle outer surface and the cover outer surface are generally flush or generally coplanar when the handle portion and the cover element are in the initial positions.

Optionally, the handle portion may be pivotally mounted to the base portion. Optionally, the cover element may be pivotally mounted to the base portion. The handle portion may be pulled outwardly away from the vehicle door to pivot toward the opening position and the cover element may be pushed inwardly toward the vehicle door to pivot toward the access position.

Optionally, the base portion may include a bezel portion that is generally flush with the exterior surface of the vehicle door when the handle assembly is mounted to the vehicle door. The handle outer surface and the cover outer surface may be generally flush or generally coplanar with an exterior surface of the bezel portion when the handle portion and the cover element are in the initial positions.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a handle assembly in accordance with the present invention;

FIG. 2 is an exploded perspective view of a pull bar handle assembly of the present invention;

FIG. 3 is a schematic of a vehicle control system utilizing the control circuitry of the door handle assembly in accordance with the present invention, where the door handle houses a passive entry system;

FIG. 4 is a schematic of a vehicle control system utilizing the control circuitry of the door handle assembly in accordance with the present invention, where the door handle interfaces with a passive entry module of the vehicle;

FIG. 5 is an exploded perspective view of a fixed handle assembly in accordance with the present invention;

FIG. 6 is an exploded perspective view of a paddle handle assembly in accordance with the present invention;

FIG. 7 is a perspective view of a vehicle with a door handle assembly in accordance with the present invention;

FIG. 8 is a perspective view of a door handle assembly of the present invention;

FIG. 9 is another perspective view of the door handle assembly, with one of the handle portions pulled outwardly from the base;

FIG. 10 is another perspective view of the door handle assembly, showing that the upper panel portion may be pushed in and the lower handle or panel portion may be pulled outwardly to open the door;

FIG. 11 is a front elevation of the door handle assembly of FIG. 10;

FIG. 12 is a lower plan view of the door handle assembly of FIGS. 10 and 11; and

FIG. 13 is an exploded perspective view of the door handle assembly of FIGS. 10-12.

### DESCRIPTION OF THE PREFERRED EMBODIMENTS

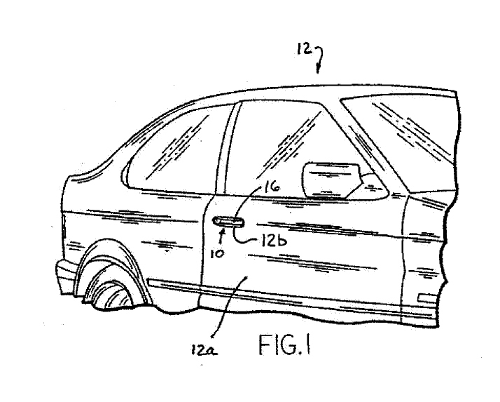

Referring now to the drawings and the illustrative embodiments depicted therein, a vehicle handle assembly or module or unit 10 is mountable to a door 12a of a vehicle 12 and operable to release a latch mechanism 13 of the door 12a to open the vehicle door (FIGS. 1-6). Vehicle handle assembly 10 includes a base portion and/or cap portion 14 that is mountable to a vehicle door and a handle or strap portion 16 that is pivotally mounted to the door or to a second or front base portion or bracket mounted to the door. Strap portion 16 is pivotable or movable or laterally movable relative to the door and the cap portion 14 to move an actuating lever or member or arm or bell crank or the like at cap portion, which in turn moves a cable or rod or linkage or the like to actuate or release the latch mechanism of the door to open the vehicle door. The handle assembly and the vehicle door may also include electronic circuitry to electronically fire or actuate an electronically controlled latch device to electronically open the vehicle door, such as in response to a detection of motion of the strap portion and/or in response to a passive entry system or the like. Handle assembly 10 includes a microprocessor or control or control circuitry 18 at the cap portion 14 and/or strap portion 16 for controlling the unlatching and/or unlocking of the vehicle door and/or the like, as discussed below.

Handle assembly 10 may comprise any suitable type of handle assembly, and may include or incorporate aspects of the door handle assemblies described in U.S. Pat. No. 6,977,619, and/or U.S. Pat. Publication No. US 2006/0038418, published Feb. 23, 2006, and/or PCT Application No. PCT/US08/062347, filed May 2, 2008, which are hereby incorporated herein by reference in their entireties. Optionally, aspects of handle assembly 10 may be suitable for use with a liftgate handle assembly for a liftgate or tailgate of a vehicle, while remaining within the spirit and scope of the present invention.

In the illustrated embodiment, handle or strap portion 16 includes a grasping portion 20 for a user to grab and pull at to open the vehicle door. The handle portion 16 also includes opposite end portions 22, 24 at opposite ends of the grasping portion 20. End portion 22 may attach to the linkages of the door mechanism at cap portion 14, while end portion 24 may pivotally or movably or laterally movably attach or mount to the vehicle door or to a bracket or the like at the vehicle door. In the illustrated embodiment, end portion 24 of strap portion 16 includes an extension or arm 24a that extends toward and partially into the door for engaging an actuating arm or engaging end of an actuating lever or the like, whereby outward movement of end portion 24 imparts a movement of the actuating lever to open the vehicle door, such as in a known manner and/or such as described in U.S. Pat. Publication No. US 2006/0038418, published Feb. 23, 2006, which is hereby incorporated herein by reference in its entirety.

Although shown as a strap type handle, the handle assembly may comprise any suitable type of vehicle door handle assembly, such as a paddle type vehicle door handle assembly (having a paddle or handle portion that is pivotable about a generally horizontal pivot axis to open the vehicle door, such as discussed below and/or such as a handle assembly of the types described in U.S. Pat. Nos. 6,349,450; 6,550,103; and 6,907,643, which ate hereby incorporated herein by reference in their entireties) or other type of vehicle door handle assembly, such as a fixed handle, such as discussed below, while remaining within the spirit and scope of the present invention. Optionally, the door handle assembly may include a soft touch handle portion, such as utilizing the principles described in U.S. Pat. Nos. 6,349,450; 6,550,103; and 6,907,643, which are hereby incorporated herein by reference in their entireties.

In the illustrated embodiment, door handle assembly 10 includes a pair of microswitches or switch elements or sensors 28a, 28b that detect movement (or are triggered by movement) of the strap portion 16 relative to the bracket or base 14 (such as a first switch 28a that detects a first or initial movement of the strap portion when a user grasps the grasping portion and begins to pull at the door handle, and a second switch 28b that detects a second or further movement of the strap portion). The microswitches preferably comprise environmentally sealed switches, where the mechanical operation is not affected by environmental factors, such as rain, ice, dirt, debris and/or the like. In the illustrated embodiment, the microswitches are part of a wiring harness, which allows for a single connection to the body side harness of the vehicle door. The control 18 is responsive to the switches 28a, 28b to actuate the latch device of the vehicle door, as discussed below.

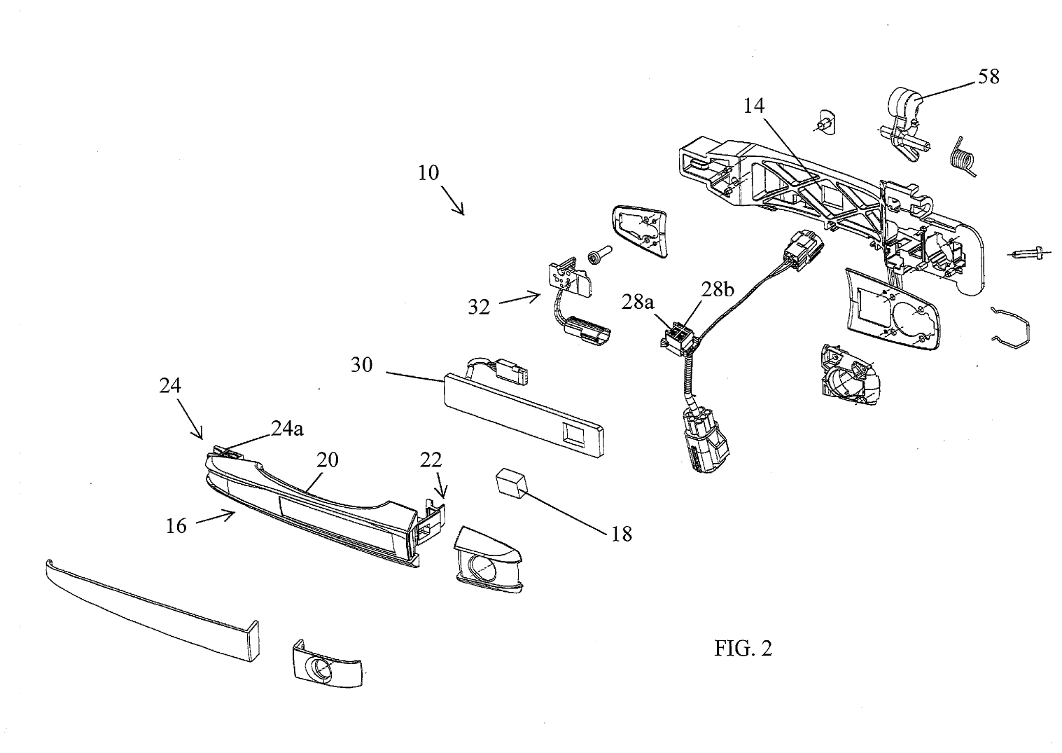

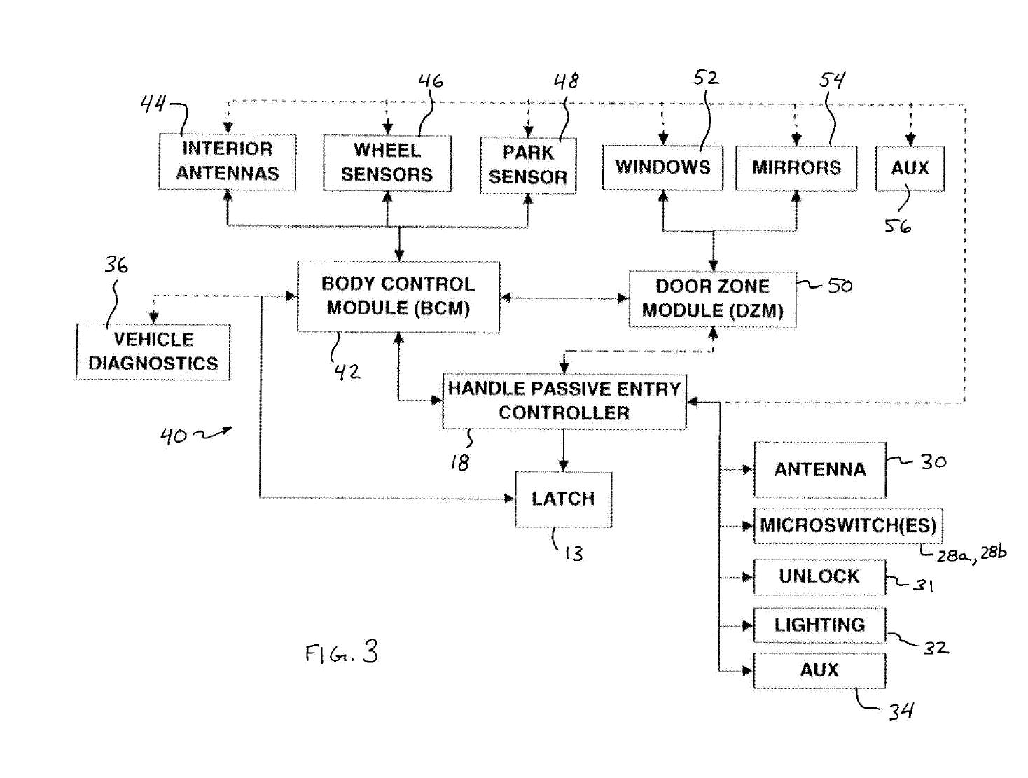

Optionally, the door handle assembly may include an antenna or the like, such as for sensing or transmitting signals, such as described in U.S. Pat. No. 6,977,619, which is hereby incorporated herein by reference in its entirety. For example, and as shown in FIGS. 2 and 3, handle assembly 10 may include an antenna or sensor 30 (such as an antenna and/or capacitive sensor) at the strap portion 16 and/or may include a passive entry device or element 31. Antenna or sensor 30 and/or passive entry device 31 may receive a signal from a transmitting device (such as from a key fob or the like carried by the driver of the vehicle) and/or may sense or detect the presence of or proximity of a person or person's hand at or near the door handle, and may generate an output signal indicative of such detection. Control 18 may be responsive to the antenna and/or sensor and/or device to authenticate or recognize the person at the vehicle door and to actuate the door latch device to open the door of the vehicle when the body control module allows for such opening, as also discussed below.

Optionally, and as shown in FIG. 2, door handle assembly 10 may include an illumination module or lighting module 32 for illuminating a portion of the door handle and/or the vehicle door or handle pocket region and/or the ground at or near the side of the vehicle. The illumination module 32 may comprise any suitable lighting module and may utilize aspects of the illumination modules described in PCT Application No. PCT/US08/062347, filed May 2, 2008, which is hereby incorporated herein by reference in its entirety. The illumination module may be operable to provide ground illumination, pocket lighting, strip lighting or projection lighting or the like, such as described in PCT Application No. PCT/US08/062347.

Optionally, the door handle control 18 may be operable to control or adjust the output of the illumination module (and/or control or adjust the output of other illumination modules of the vehicle, such as at an exterior rearview mirror of the vehicle or the like). For example, the door handle control may gradually activate or ramp up the illumination output or may gradually deactivate or dim the illumination output to provide a type of “theater lighting” at the door handle and in response to a user input or a detection of the approach of a person or recognized device.

Optionally, the door handle control may be programmable to control the illumination module in a manner that provides different color outputs or different lighting effects, depending on the particular application and the desires of the consumer. For example, the illumination module may include three different color light emitting diodes and the door handle control may selectively activate or energize the light emitting diodes at different intensity levels to produce a selected color of the illumination output. Thus, the door handle manufacturer and/or the vehicle manufacturer may offer exterior (and optionally interior as well) lighting options to the consumer.

Although shown in FIG. 2 as being disposed at the antenna assembly and handle portion of the door handle assembly or module, it is envisioned that the door handle microprocessor or control may be otherwise disposed at or in the door handle assembly. For example, the microprocessor or control or control circuitry may be packaged into or at the antenna assembly of the door handle assembly or into or at a capacitive sensor of the door handle assembly or into or at tactile switches or microswitches of the door handle assembly, or into an illumination module of the door handle assembly or into or at the bracket or base of the door handle assembly or into the strap handle of the door handle assembly and/or the like.

Optionally, it is envisioned that the door handle assembly or module of the present invention may be operable to control other accessories or devices of the vehicle door and/or of the vehicle. For example, the door handle control may control operation of the window controls and/or of the exterior mirror actuator controls or the like. The door handle control and the door handle module of the present invention thus may reduce the load on the door zone module or passive entry system of the vehicle door and may even obviate the need for a separate and remotely located door zone module or passive entry system. In such an application, the door handle manufacturer or supplier could supply all of the door controls (such as the window and exterior mirror and door handle and door latch controls) as a fully compatible and complete system, which would further enhance performance of the door accessories or components or devices.

Optionally, and although shown and described as having a pair of microswitches for indicating movement of the door handle by a person at the vehicle door, it is envisioned that the door handle control may be operable in response to other detecting means, such as tactile buttons or switches or contacts or magnetoresponsive sensors and associated magnetic elements and/or the like, at the door handle that detect the presence of or pressure exerted by a person at the door handle or that detect movement of the door handle. For example, it is envisioned that a door handle assembly or module may comprise a fixed handle (such as discussed below) or fixed door opening device or actuator or assembly or module. In such an embodiment, the door opening module may include one or more capacitive sensors or tactile buttons (instead of the microswitches that detect movement of a strap or paddle portion of a handle) in or on the door opening module that may be operable to initiate the passive entry system. Thus, a person could open the vehicle door by approaching the vehicle door and/or moving their hand toward and/or into contact with the door opening module, whereby the input elements may activate the passive entry system and may actuate the latch device, such as in a similar manner as described above. The fixed handle or door opening module may include a door handle control such as described above.

As shown in FIG. 3, a vehicle control system 40 includes a body control module 42, which may be in communication with one or more interior antennae 44 of the vehicle, one or more wheel sensors 46 of the vehicle and a park sensor 48 of the vehicle. Body control module 42 may comprise any suitable vehicle control module or body control module, such as is typically disposed at or in the interior of the vehicle, such as in the interior cabin of the vehicle. The vehicle system 40 also includes a door zone module 50 (typically disposed in the vehicle door), which may be in communication with the window controls 52 and the mirror controls 54. As also shown in FIG. 3, the body control module 42 may be in communication with the door zone module 50 (such as via any suitable communication link, such as a wireless communication link, a LIN communication link, a CAN/bus communication link, a discreet or hard-wired communication link and/or the like) and may be in communication with the door handle control 18 (such as via any suitable communication link, such as a wireless communication link, a LIN communication link, a CAN/bus communication link, a discreet or hard-wired communication link and/or the like). In the illustrated embodiment, the door handle microprocessor or control 18 is disposed at or in or incorporated in the vehicle door handle assembly (or liftgate handle assembly) and thus is proximate to and/or directly connected to or wired to the antenna 30, the first microswitch 28a, the second microswitch 28b, the unlock device 31 (such as a key lock or the like of the door handle) and/or a lighting module 32 of the door handle. The door handle control 18 may control the door latch 13 in response to the switches and antenna and the like, and may communicate with the body control module during the door opening process. In the illustrated embodiment, the passive entry device or element or circuitry is incorporated into the handle controller, whereby the handle controller may communicate only with the body control module 42 to open the vehicle door upon receipt of the appropriate signal or signals (such as from the microswitches and/or the antenna or the like).

As shown in FIG. 3, the door zone module 50 is separate from the door handle control 18 and may communicate with the body control module 42 and may control the window controls 52 and the mirror controls 54. Thus, the door handle control 18 is separate from the door zone module and may actuate the door latch 13 without communication with the door zone module and thus, via a more direct and less complex communication network. By locating the door handle control 18 (and optionally with the passive entry circuitry incorporated therein) in the door handle assembly, the door handle assembly provides a self sustaining unit that may check itself (such as by monitoring the switches of the door handle assembly) and that may provide a faster response time as compared to communication or control systems utilizing the remotely located door control module to actuate the door latch. The door handle control 18 may check or monitor the microswitches 28a, 28b continuously, and may determine if one of them is inoperable or malfunctioning. If one of the switches is inoperable or malfunctioning, the control may set a fault code and use only the other switch to operate or open the vehicle door.

Optionally, the handle control 18 and the body control module 42 may be in communication with other systems or devices, such as other auxiliary systems or devices or sensors 56 of the vehicle and/or other auxiliary systems or devices or sensors 34 of the vehicle door (or liftgate). For example, the auxiliary device or system or sensor may comprise a crash sensor and/or airbag monitor or sensor or the like. By communicating with such sensors or devices, the handle control 18 may unlock or open the vehicle door or may limit unlocking or opening of the vehicle door in response to output signals of the crash sensor and/or airbag. For example, if the handle control receives a signal indicative of deployment of the airbag and/or a crash of the vehicle and the vehicle is in park, the handle control may unlock the door of the vehicle. Likewise, if the handle control receives a signal indicative of deployment of the airbag and/or a crash of the vehicle, but the vehicle is not in park, the handle control may function to keep the vehicle door locked and may ignore signals that attempt to open the vehicle door, since the vehicle may still be moving and the opening of the vehicle door would not be safe at that time. Thus, the handle control of the present invention may automatically unlock and/or open the vehicle door after a crash or airbag deployment event is detected and when it is safe to open the vehicle door (such as when the vehicle is in park), and/or may limit or prevent opening of the vehicle door following detection of a crash or airbag deployment when it is not safe to open the vehicle door (such as when the vehicle is not in park).

Optionally, the body control module 42 and/or the handle control 18 may be in communication with a vehicle diagnostics system or device 36 to further enhance communication with the vehicle to determine the status of the vehicle. The circuitry within the door handle controller or passive entry system may have the ability to self-diagnose system failures or current states within the door handle controller and passive entry system and other components. The door handle controller may function to send or communicate such information back to the vehicle diagnostics system 36.

Optionally, the handle assembly 10′ may include a power source or battery backup to provide power to the electronic circuitry of the handle assembly (and of the door latch if an electronically operable door latch). The battery backup may provide sufficient power to unlock and/or open the door or liftgate of the vehicle when the primary power supply is not providing power (such as when the vehicle battery is dead or disconnected or the like). Thus, the battery backup of the handle assembly may provide sufficient power for firing or actuating the door latch to open the vehicle door at least one time. Such a backup power source is particularly beneficial for electric vehicles, since a fully electronic door handle may not otherwise open if the vehicle battery were dead or disconnected. With the backup power source, even when the vehicle battery is no longer functional, the user may open the door of the vehicle at least one more time by utilizing the backup batter or backup power source of the handle assembly.

During normal operation of the door handle assembly, when a user approaches and grasps the door handle and initially moves the door handle to open the door, the first microswitch 28a tells the door handle control to initiate the passive entry function, whereby the door handle passive entry controller or control 18 checks or monitors the signal received from the antenna 30 of the door handle assembly for authentication that the user at the door of the vehicle is carrying the appropriate passive entry device (such as a key fob or the like detected by the antenna and/or passive entry device of the door handle assembly). If the key fob or device is recognized and verified or authenticated, the door handle control communicates a signal to the body control module that is indicative of such authentication, whereby the body control module 42 sends an unlock signal to the latch 13 if the body control module also verifies that the person at the side of the vehicle is approved or recognized for entry into the vehicle. As the handle is pulled or moved further by the user, the door handle control, responsive to the second microswitch 28b (which detects such further movement and generates an output signal indicative thereof), actuates the unlocked latch to open the vehicle door.

Thus, the incorporation of a door handle control as part of a door handle assembly or module provides enhanced control of the door latch in response to the door handle switches and provides enhanced control of the door opening system. The door handle control, being at the door handle assembly and not part of the door zone module or a separate passive entry system in the door, does not necessarily get involved with the other door zone module or passive entry system control issues. The door handle control thus is autonomous and is not affected by other door control issues, while the body control module of the vehicle is still responsible for allowing the door latch to open.

Also, the door handle control of the present invention may detect a malfunctioning or inoperable switch at the door handle, and may allow for opening of the vehicle door in response to the single switch (and the passive entry device or system if applicable), such that even with a bad switch, the customer can still enter vehicle. Also, because the door handle control is part of the door handle assembly or module, any malfunction code set by the door handle control will indicate that there is a concern or-malfunction with the door handle assembly, and thus the present invention provides enhanced warranty issues, since it may substantially reduce erroneous warranty codes that may otherwise be generated by the door zone module or a separate passive entry system.

Also, the incorporation of the door handle control as part of a door handle assembly or module allows the door handle supplier to package more content into the door handle assembly or module. Further, the door handle supplier may bundle or sell vehicle door electronics, door handles, and latches as a complete system. This allows the vehicle door handle supplier to also supply its own passive entry system (as part of the door handle assembly or module) to the vehicle platforms, which provides an enhanced and efficient and cost effective solution for the vehicle manufacturer.

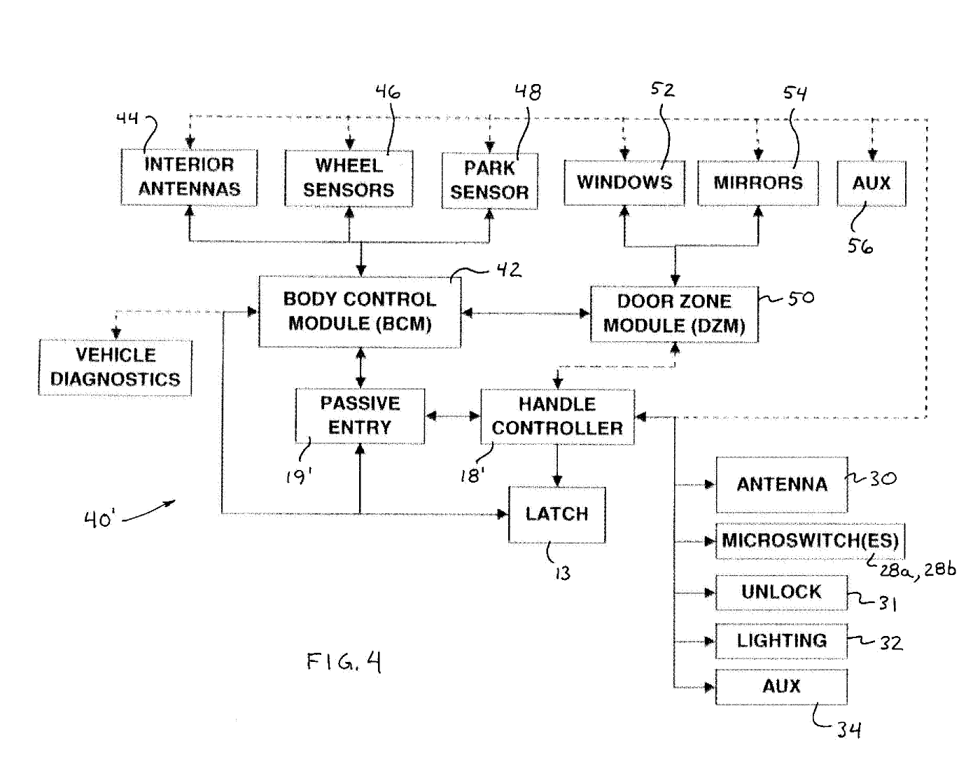

Optionally, and with reference to FIG. 4, a vehicle control system 40′ includes a body control module 42, a passive entry device or system 19′ and a handle controller or handle control module 18′ or the like. Handle control 18′ is separate from passive entry system 19′, and communicates with passive entry system 19′ to unlock and/or open the vehicle door, such as in a similar manner as described above. Vehicle control system 40′ may be substantially similar to vehicle control system 40, discussed above, such that a detailed discussion of the vehicle control systems need not be repeated herein. The same or similar components or functions are shown with the same reference numbers in FIGS. 3 and 4.

By providing a handle control 18′ without a passive entry system or circuitry incorporated therein, the handle control may be “plugged into” any system and may communicate with the existing or compatible passive entry system of the vehicle or door. Likewise, by providing a handle control 18 with the passive entry system or circuitry incorporated therein, the handle assembly may be implemented on any vehicle door, without having to check compatibility with a separate passive entry system of the equipped vehicle. Thus, if a vehicle manufacturer selected one supplier for its passive entry system and another supplier for its door handle assembly, the door handle control could be supplied without the passive entry circuitry for such a system, while if a vehicle manufacturer selected the same supplier for both its door handle assembly and passive entry system, the door handle control could be supplied with the passive entry circuitry incorporated therein.

Thus, the door handle assembly or module may be provided as a single unit or module that is mounted at the vehicle door and that includes its own sensors and its own circuitry or control for controlling the door latch of the vehicle door and/or other accessories or devices of the vehicle door and/or of the vehicle. Optionally, the door handle assembly and door latch (and optionally other accessories or devices) may be provided by a common supplier as a unit or as a door opening system to provide enhanced compatibility and performance to the vehicle door handle. Optionally, the electrical connection and mechanical connection of the self-contained door handle assembly or module may be made as the module is snapped or otherwise inserted or mounted or attached to the vehicle door, such as by utilizing aspects of the accessory modules described in U.S. Pat. Nos. 6,669,267; 6,969,101; 6,824,281; and/or 7,188,963, which are hereby incorporated herein by reference in their entireties.

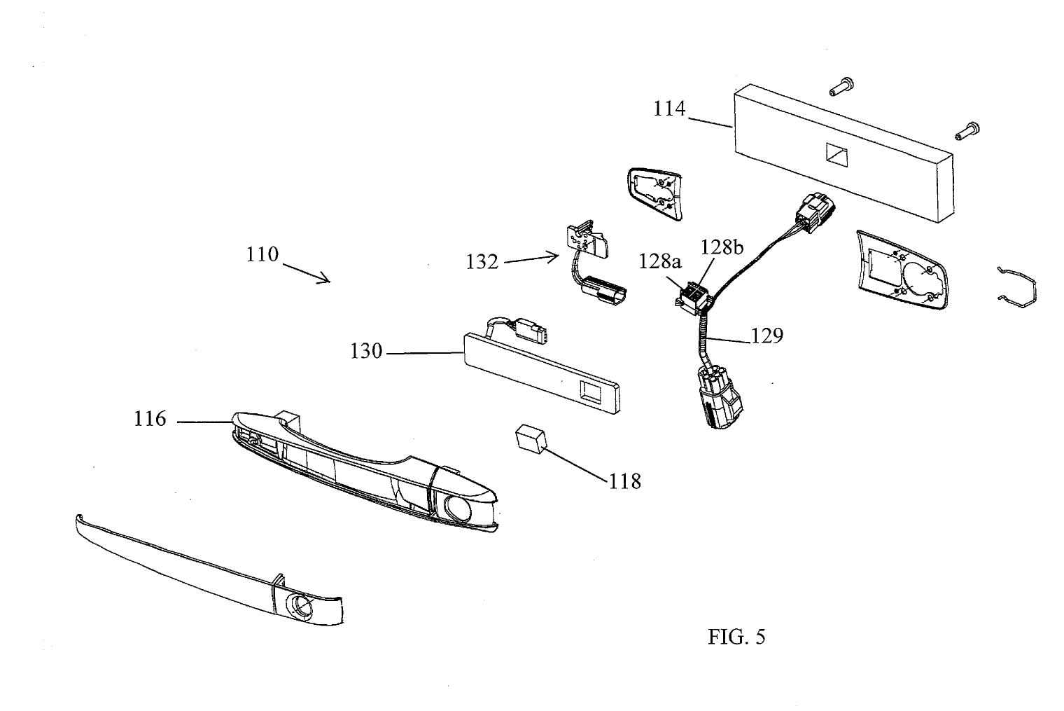

Optionally, and with reference to FIG. 5, a fixed vehicle door handle assembly or module or unit 110 is fixedly mountable to a door of a vehicle and operable to release a latch mechanism (such as an electrically operable latch mechanism or device) of the door to open the vehicle door. Handle assembly 110 includes a handle control or controller or control circuitry or module or microprocessor 118, such as in a similar manner as handle assembly 10, discussed above. Fixed handle assembly 110 includes a fixed strap portion 116 that is fixedly attached to a base portion or bracket 114, which is mounted at the vehicle door. In the illustrated embodiment, fixed handle assembly 110 also includes microswitches 128a, 128b, an antenna and/or capacitive sensor 130, an illumination module 132, which may be similar to the components of movable handle assembly 10, discussed above, such that a detailed discussion of these components need not be repeated herein.

In the illustrated embodiment, handle control 118 is disposed at the antenna/sensor 130, but may be disposed or received or located at other regions of the door handle assembly 110. For example, control 118 may be packaged or located or disposed at or in the strap handle 116, the light module 132, the bracket 114 or the switch assembly and/or wire harness assembly 129 or the like. Control 118 may be substantially similar to and operate in a similar manner as handle control 18, discussed above, such that a detailed discussion of the handle controls and vehicle control systems need not be repeated herein.

By providing a fixed handle or fixed door opening device or module, the present invention provides a door opening module wherein the typical handle mechanical operation is eliminated, and may provide more freedom for new handle designs, Such a fixed door opening module may also provide enhanced mounting to the sheet metal and enhanced manufacturing of the door assemblies. Such a fixed door opening module may provide enhanced performance as well, since there would be no tendency to open in a collision and since the door opening module would thus not require a counterweight (such as is typically located in a movable door handle assembly, such as the counterweight 58 of the pull strap handle assembly 10 shown in FIG. 2, to limit opening or moving of the handle during a collision). Also, the fixed door opening module may provide any desired handle or opening efforts or opening forces via selection of the sensors or devices and/or programming of the door handle control or control circuitry. Such a fixed door opening module may also achieve greater quality ratings by reducing wind noise, squeaks, rattles and the like and by providing a flush exterior surface at the side door of the vehicle. The fixed handle or fixed door opening device or module thus may provide enhanced performance and may be a less costly handle for the vehicle manufacturers.

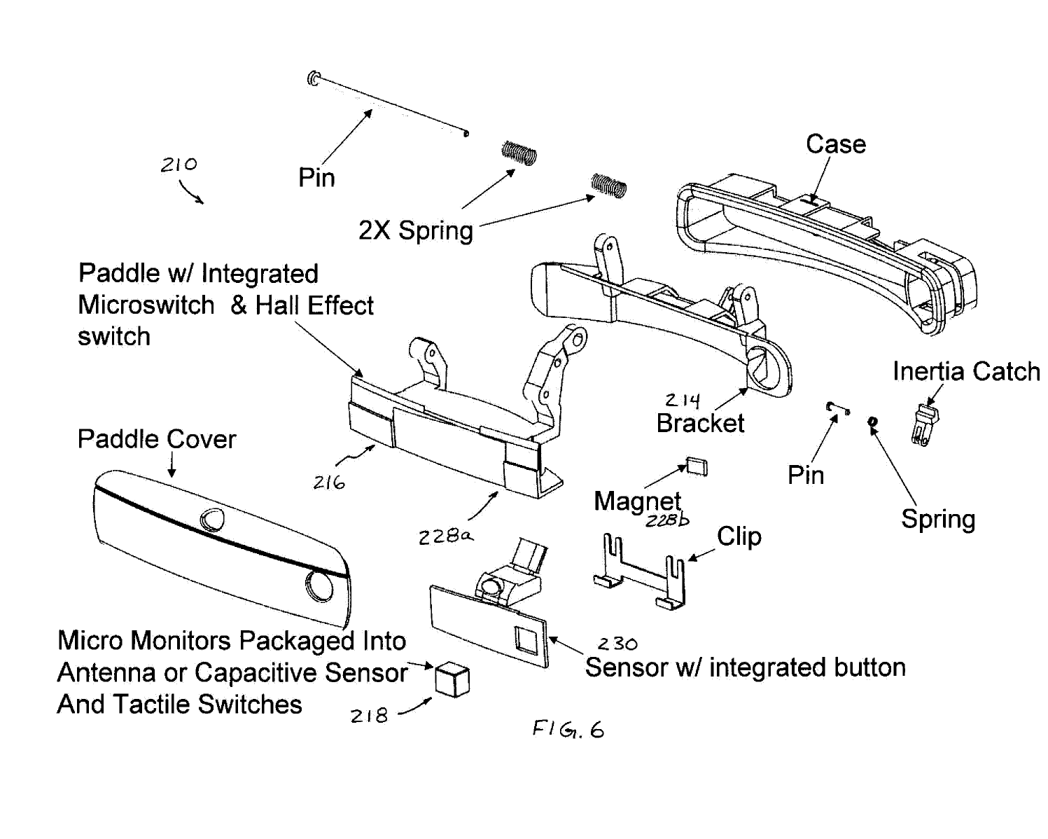

Optionally, and with reference to FIG. 6, a paddle-type vehicle door handle assembly or module or unit 210 is mountable to a door of a vehicle and operable to release a latch mechanism of the door to open the vehicle door. Handle assembly 210 includes a handle control or controller or control circuitry or module or microprocessor 218, such as in a similar manner as handle assemblies 10, 110, discussed above. Paddle handle assembly 210 includes a paddle portion 216 that is movably or pivotally attached to a base portion or bracket 214, which is mounted at the vehicle door. In the illustrated embodiment, paddle handle assembly 210 also includes a magnetoresponsive sensor 228a (such as a Hall Effect sensor or switch) at or integrated with the paddle portion 216 and a magnetic element 228b at the bracket or door, and also may include an antenna and/or sensor 230, and/or an illumination module and/or the like, which may be similar to the components of movable handle assembly 10, discussed above, such that a detailed discussion of these components need not be repeated herein. Paddle handle assembly 210 may utilize aspects of the handle assemblies described in U.S. Pat. Nos. 6,349,450; 6,550,103; and 6,907,643, which are hereby incorporated herein by reference in their entireties.

In the illustrated embodiment, handle control 218 is disposed at the antenna/sensor 230, but may be disposed or received or located at other regions of the door handle assembly 210.

For example, control 218 may be packaged or located or disposed at or in the paddle portion 216, the light module, the bracket 214 or the sensor/switch assembly and/or a wire harness assembly or the like. Control 218 may be substantially similar to and operate in a similar manner as handle control 18, discussed above, such that a detailed discussion of the handle controls and vehicle control systems need not be repeated herein.

In the illustrated embodiment, handle assembly 210 includes Hall Effect sensor 228a that detects movement of or proximity of magnet or magnetic element 228b to detect or determine movement of paddle portion 216 relative to base or bracket 214. Optionally, a sensor 230 may continuously or periodically look for the presence of a user's hand or the like in proximity of the door handle, whereby upon detection of the user, the control may function to unlock the vehicle door, such as in a similar manner as described above. In order to reduce the draw on the vehicle battery or power source, the sensor and system may shut down after a period of time where a user is not detected. When the system is deactivated, the sensor 228a may function to activate or “wake up” the handle control upon detection of movement relative to magnetic element 228b or proximity of magnetic element 228b (such as a detection that magnetic element 228b is within a threshold distance from sensor 228a or the like).

Optionally, the paddle handle assembly may include microswitches (such as those described above) to detect movement of the paddle portion, such as in a similar manner as described above with respect to strap handle assembly 10. In applications with the microswitches, the handle control need not continuously monitor the sensors for detection of a user's hand or the like, since the control may be responsive to an output signal of the first microswitch upon a user contacting or moving the handle at-the vehicle door. Optionally, it is envisioned that, if desired, a strap handle assembly may incorporate a magnetoresponsive sensor and magnetic element in a similar maimer as described above with respect to paddle handle assembly.

Thus, the handle controller or microprocessor or control module of the present invention may be operable to communicate with the vehicle control module (and optionally with a passive entry system of the vehicle) to unlock the vehicle door or liftgate in response to detection of and recognition/authorization of the person attempting to open the vehicle door or liftgate. Aspects of the control modules described above may be suitable for any type of door handle, such as a pull strap handle, a fixed handle, a paddle handle or the like, either for a side vehicle door or a liftgate or tailgate of a vehicle. Optionally, the handle control may be responsive to microswitches, capacitive sensors, tactile buttons or switches or contacts, magnetoresponsive sensors and associated magnetic elements and/or the like, to detect the presence of or proximity of a user at the vehicle door or liftgate.

Optionally, the door handle assembly or module may incorporate other features or accessories, such as, for example, a blind spot indicator device or element and/or a turn signal indicator device or element, such as by utilizing aspects of the devices described in U.S. provisional applications, Ser. No. 61/031,869, filed Feb. 7, 2008; Ser. No. 61/022,450, filed Jan. 21, 2008; Ser. No. 60/954,953, filed Aug. 9, 2007; Ser. No. 60/985,446, filed Nov. 5, 2007; Ser. No. 61/019,478, filed Jan. 7, 2008; Ser. No. 60/853,850, filed Oct. 24, 2006; Ser. No. 60/918,089, filed Mar. 15, 2007; and/or Ser. No. 60/970,687, filed Sep. 7, 2007, and/or U.S. Pat. Nos. 6,198,409; 5,929,786; and 5,786,772, and/or U.S. patent application Ser. No. 11/994,471, filed Jan. 2, 2008, now U.S. Pat. No. 7,492,281, and/or PCT Application No. PCT/US07/82099, filed Oct. 22, 2007, which are hereby incorporated herein by reference in their entireties. The signal indicator or indication module may include or utilize aspects of various light modules or systems or devices, such as the types described in U.S. Pat. Nos. 6,227,689; 6,582,109; 5,371,659; 5,497,306; 5,669,699; 5,823,654; 6,176,602; and/or 6,276,821, and/or U.S. patent application Ser. No. 11/520,193, filed Sep. 13, 2006 (Attorney Docket DON01 P-1286), and/or PCT Application No. PCT/US2006/018567, filed May 16, 2006 and published Nov. 23, 2006 as International Publication No. WO 2006/124682, which are hereby incorporated herein by reference in their entireties.

Optionally, the door handle assembly or module may include or may be associated with an antenna for receiving signals from or communicating with a remote device. For example, the antenna (such as, for example, an antenna of the types described in U.S. Pat. No. 6,977,619, which is hereby incorporated herein by reference in its entirety) may communicate a signal to the door locking system via a wire connection or the like, or wirelessly, such as via a radio frequency signal or via an infrared signal or via other wireless signaling means. Such connections can include cables, wires, fiber optic cables or the like. The communication to the locking system may be via a vehicle bus or multiplex system, such as a LIN (Local Interconnect Network) or CAN (Car or Controlled Area Network) system, such as described in U.S. Pat. Nos. 6,291,905; 6,396,408; and/or 6,477,464, which are all hereby incorporated herein by reference in their entireties. The vehicle door may then be unlocked and/or the illumination source or sources may be activated as a person carrying a remote signaling device approaches the door handle. Optionally, other systems may be activated in response to the remote signaling device, such as vehicle lighting systems, such as interior lights, security lights or the like (such as security lights of the types disclosed in U.S. Pat. Nos. 6,280,069; 6,276,821; 6,176,602; 6,152,590; 6,149,287; 6,139,172; 6,086,229; 5,938,321; 5,671,996; 5,497,305; 6,416,208; and/or 6,568,839, all of which are hereby incorporated herein by reference in their entireties), or the vehicle ignition, or any other desired system, while remaining within the spirit and scope of the present invention.

A door handle for a vehicle door typically includes a handle portion that is pivotable relative to a base portion, whereby pivotal movement of the handle portion pulls at a cable or rod to electrically trigger or move a latch mechanism to release the latch and open the door. Typically, a door handle is a pull strap handle with a strap handle portion that protrudes outwardly from the side of the vehicle for grasping by the person opening the door of the vehicle. Alternately, paddle type door handle assemblies are known, where a paddle portion is pivotally mounted to a base portion and is pulled generally outwardly and upwardly to open the vehicle door. Such paddle type door handle assemblies typically protrude outwardly from the vehicle door when in their unpulled state and have an open recess below the paddle portion for receiving a user's fingers for grasping the paddle portion.

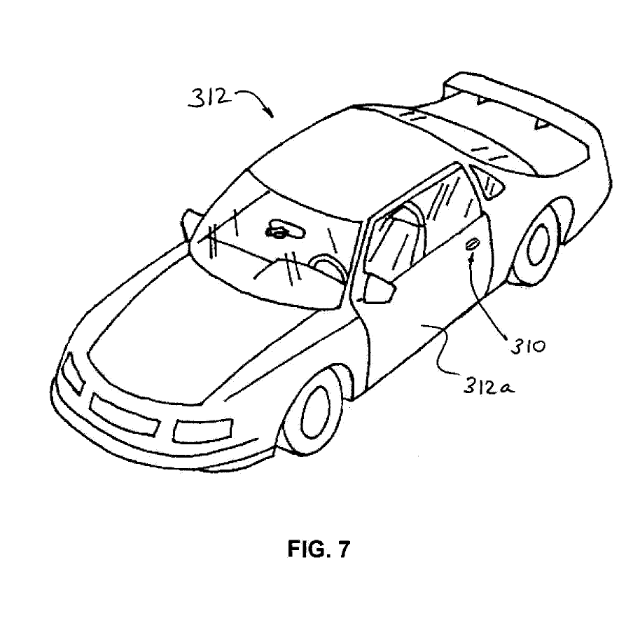

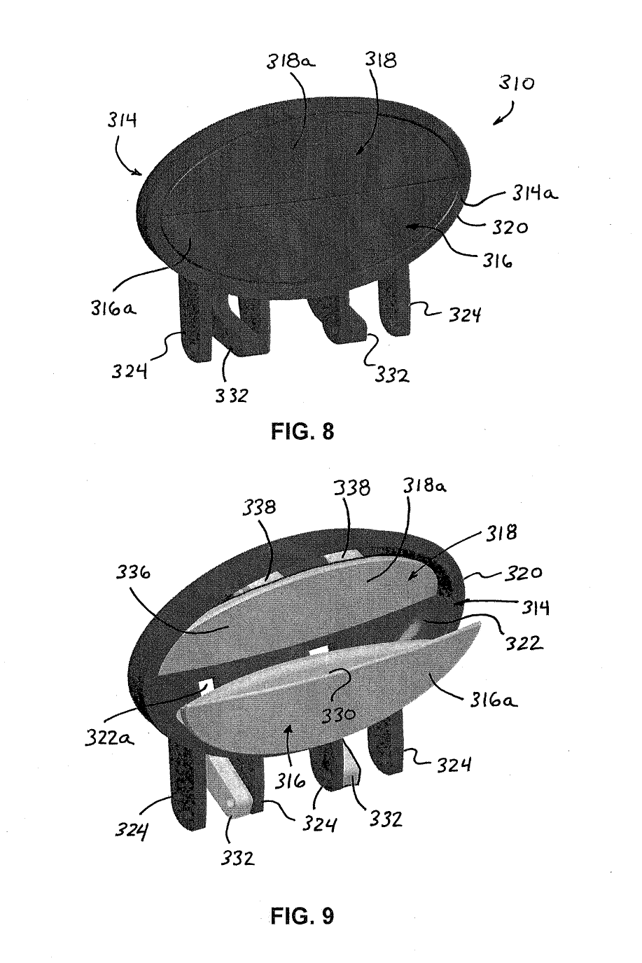

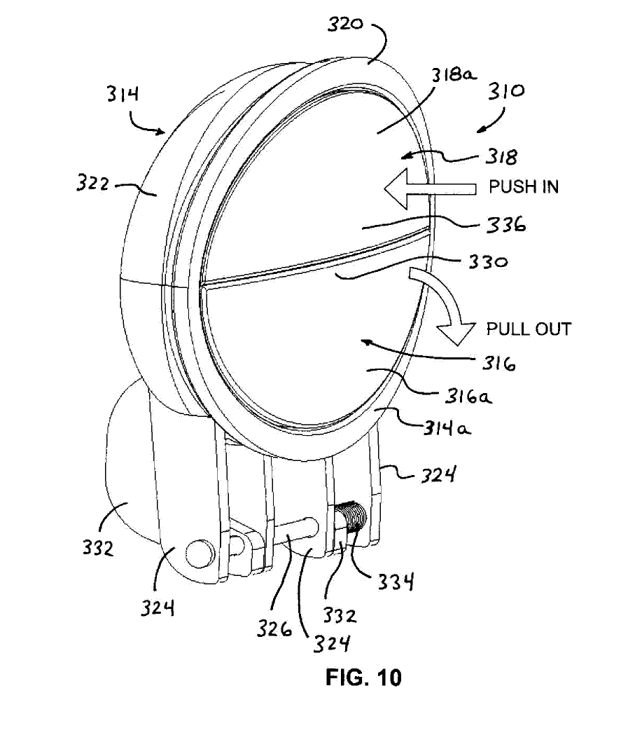

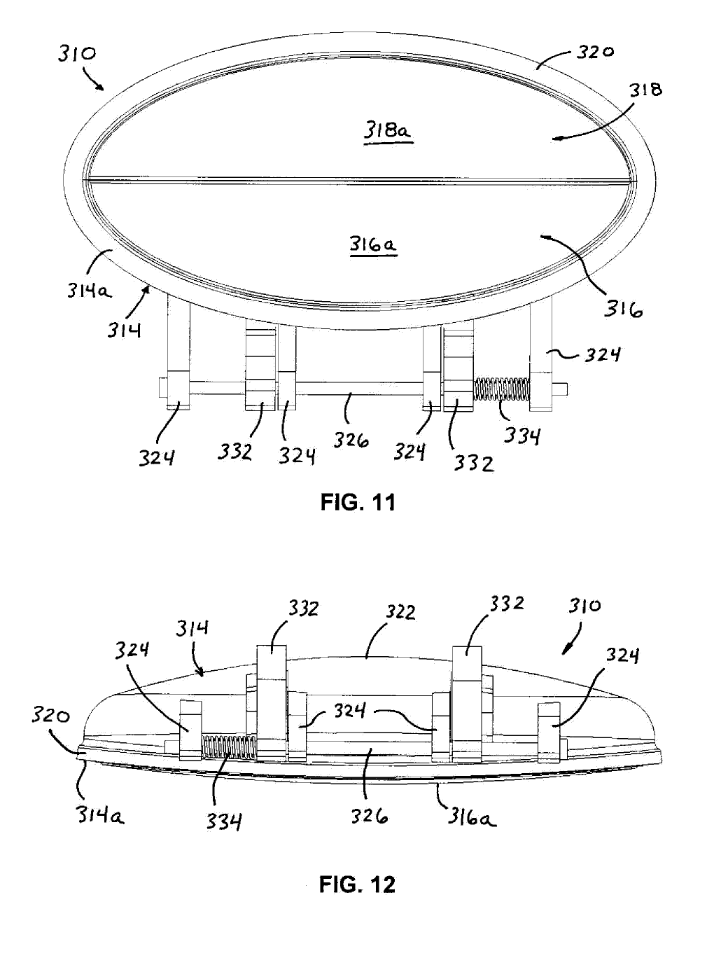

Optionally, and with reference to FIGS. 7-13, a vehicle door handle assembly 310 is mountable to a door 312a of a vehicle 312 and operable to release a latch mechanism of the door 312a to open the vehicle door (FIG. 7). Vehicle door handle assembly 310 includes a base portion or mounting structure 314 that is mountable to a vehicle door and within a recess at the vehicle door, with a pull bar or handle portion 316 that is pivotally mounted to the base portion 314. Handle portion 316 is pivotable or movable relative to the door and the base portion 314 to move an actuating lever or member or cable or rod or linkage or the like to actuate or release the latch mechanism of the door to open the vehicle door. Door handle assembly 310 includes a push bar or cover or panel portion or element 318 pivotally or movably mounted at base portion 314. The outer surfaces 316a, 318a of handle portion 316 and cover portion 318, respectively, are generally flush or generally coplanar with one another and with the outer surface 314a of base portion 314, and generally flush or generally coplanar with the exterior panel of the vehicle door 312a, when in their non-pushed or non-pulled state (such as when the vehicle door is not being opened), such as shown in FIGS. 7, 8 and 10-12 and as discussed below.

Base portion 314 of door handle assembly 310 includes bezel portion 320, which is disposed around a perimeter region of a recessed or pocket portion 322 of base portion 314. Pocket portion 322 is received within a recessed portion of the vehicle door, while bezel portion 320 is located generally at the exterior surface of the exterior door panel of the door, when the door handle assembly 310 is mounted to the door. Base portion 314 includes a plurality of protrusions or mounting legs or arms 324 for mounting or receiving a pivot pin 326, which pivotally mounts handle portion 316 to base portion 314, as discussed below. In the illustrated embodiment, mounting legs 324 extend downwardly from pocket portion 322, whereby the handle portion 316 is at a lower region of base portion 314 (but clearly, the mounting legs may otherwise extend from the pocket portion and the handle portion may otherwise be arranged at the base portion, without affecting the scope of the present invention). Base portion 314 also includes a mounting structure 328 at its opposite or upper region (or elsewhere) for pivotally mounting cover element 318, as also discussed below.

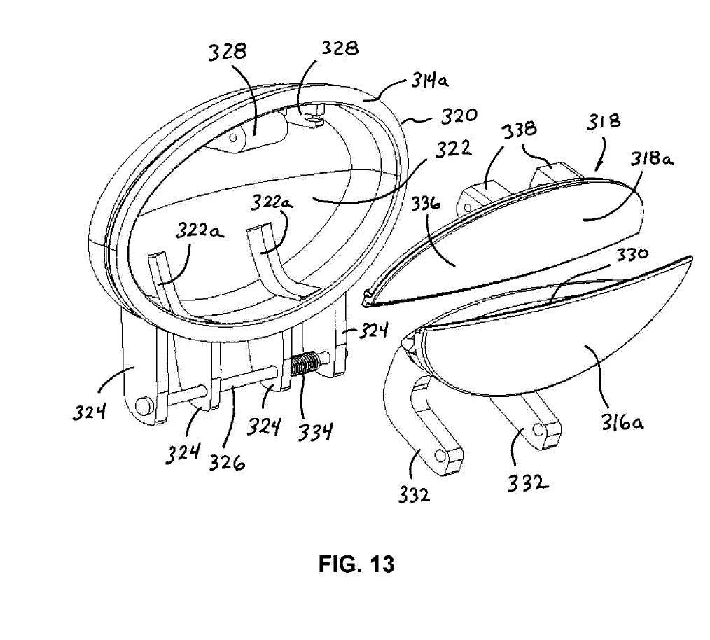

Handle portion 316 includes a grasping portion 330 for a user to grab and pull at to open the vehicle door. The handle portion 316 also includes legs or arms or extensions 332 that extend from grasping portion 330 and pivotally mount handle portion 316 to base portion 314, such as via pivot pin or axle 326 or the like. One or both of the arms 332 may connect to a linkage mechanism for actuating the door latch mechanism to open the vehicle door upon pulling outwardly of the handle portion and pivoting the handle portion about the pivot pin 326. As shown in FIG. 13, pocket portion 322 of base portion 314 may include one or more slots or apertures 322a established through pocket portion 322 to allow arms 332 to extend through the wall of pocket portion 322 for connection to pivot pin 326.

Pivot pin 326 extends through apertures or holes in mounting legs 324 of base portion 314 and through apertures or holes in legs or arms 332 of handle portion 316. A biasing element 334, such as a torsional spring or the like, may be provided at pivot pin 326 to bias the pivot pin 326 and handle portion 316 toward a non-use or non-pulled state. Thus, the handle portion 316 may be pulled outward, with the arms 332 imparting rotation of pivot pin 326 against the urging of biasing element 334, and the biasing element 334 will urge the pivot pin 326 and handle portion 316 back to their initial or non-pulled state upon release of the handle portion by the person opening the vehicle door, whereby the handle portion 316 is returned to its orientation where the outer surface 316a of handle portion 316 is generally flush with the outer surface 318a of cover element 318 (and generally flush with the outer surface of the bezel portion and/or the outer surface of the vehicle door).

Cover element 318 includes a panel portion or pushing portion 336 for a user to push against to move the cover element inward so as to be able to access handle portion 316 and grab and pull at handle portion 316 to open the vehicle door. The cover element also includes mounting extensions 338 that extend from pushing portion 336 and that movably or pivotally mount cover element 318 to the mounting structure 328 of base portion 314, such as via a pivot pin or axle or the like. The base portion 314 or cover element 318 may include a biasing element (such as a torsional spring or the like) and/or a dampening element or mechanism to control the pivotal movement of the cover element 318 at the base portion 314. For example, movement of the cover element may be dampened so as to limit or reduce the rate of return of the cover element to its initial or non-pushed orientation, so that a user can push the cover element inward and grasp and pull the handle portion without having the cover element spring back toward its initial position and possibly pinch the user's fingers.

Thus, the exterior door handle includes of three main parts: a base portion mounted to the vehicle door with a generally flush bezel portion, a push bar or cover element portion, and a pull bar or handle portion connected to the latching mechanism of the door. The bezel portion is mounted at or in a recessed portion or aperture of the vehicle door such that the surrounding surface of the door is generally flush or aligned collinearly with the outer surface of the bezel portion. The push bar or cover element or portion is mounted to the base portion utilizing a pivot pin, a spring and a damper mechanism. The movement of the cover element is limited to inward movement (such as swinging movement) to facilitate access to the grasping portion of the handle portion. The pull bar or handle portion is mounted to the base portion using a second pivot pin and torsion spring system and is mounted to or connected to an attachment to the latching device or mechanism of the door.

To operate the door handle, the user may push the cover element or push bar inwardly so as to pivot the push bar about its pivot pin. This then allows the user to grip the pull bar or handle portion from the inside surface of the grasping portion and to pull the handle portion outwardly about its pivot pin until the latching mechanism opens the vehicle door. The push bar or cover element includes a spring and dampening mechanism that holds the cover element so that its outer surface is generally flush with the surrounding bezel portion and door, and also delays the return of the cover element after the user pushes it inward. This allows the user to grip the handle portion without the cover element immediately returning to its normal position and thus pinching the user's fingers. Optionally, the door handle assembly may include a soft touch handle portion (such as with a soft touch material at the inner surface of the grasping portion where a user grasps the handle portion and pulls the handle portion outward to open the vehicle door) and/or a soft touch cover element (such as with a soft touch material at the outer surface of the cover element where a user pushes against the cover element), such as by utilizing aspects of the handle assemblies described in U.S. Pat. Nos. 6,349,450; 6,550,103; and 6,907,643, which are hereby incorporated herein by reference in their entireties.

Although shown and described as having the handle portion at the lower region of the handle assembly and the cover clement at the upper region of the handle assembly, the handle assembly may have them otherwise arranged, such as, for example, with the handle assembly above the cover element, while remaining within the spirit and scope of the present invention. Optionally, the door handle assembly may be oriented so that the handle portion and cover element pivot about either a generally horizontal axis (as shown in FIGS. 7-13) or a generally vertical axis or other axis when the handle assembly is mounted on a vehicle door, while remaining within the spirit and scope of the present invention.

Optionally, the door handle assembly may be electronically or automatically operable, such as in response to a signal from a key fob or a passive entry system or the like. For example, the door handle assembly may include a motor that is operable to pivot the handle portion or to otherwise actuate the door latch mechanism to open the vehicle door in response to a user input or in response to a signal received from a transmitting device or in response to a detection of a recognized device (such as for a passive entry system or the like). Optionally, the door handle assembly may include circuitry for controlling actuation of the door latch mechanism and the like, such as by utilizing aspects of the control systems described in U.S. provisional application Ser. No. 61/079,231, filed Jul. 9, 2008, which is hereby incorporated herein by reference in its entirety. The door handle assembly may include or incorporate aspects of the door handle assemblies described above and/or in U.S. Pat. Nos. 6,349,450; 6,550,103; 6,907,643; 6,977,619; and/or 7,407,203, and/or PCT Application No. PCT/US08/062347, filed May 2, 2008, and/or U.S. provisional application Ser. No. 61/079,231, filed Jul. 9, 2008, which are hereby incorporated herein by reference in their entireties.

Optionally, the door handle assembly may include an illumination module, such as an illumination module of the types described above and/or in U.S. Pat. Nos. 6,349,450; 6,550,103; and/or 6,907,643, PCT Application No. PCT/US08/062347, filed May 2, 2008, and/or U.S. provisional application Ser. No. 61/079,231, filed Jul. 9, 2008, which are hereby incorporated herein by reference in their entireties. Optionally, the door handle assembly may have a back lit portion (such as the grasping portion of the handle portion and/or the cover or panel portion of the cover element) that is back lit by an illumination source or module, such as by utilizing aspects of the illumination modules described above and/or in PCT Application No. PCT/US08/062347, filed May 2, 2008, and/or U.S. provisional application Ser. No. 61/079,231, filed Jul. 9, 2008, which are hereby incorporated herein by reference in their entireties. Optionally, the illumination module may provide a back lit icon or indicia or logo or emblem to provide enhanced ground illumination at the side of a vehicle, and the icon or indicia or logo or emblem may comprise the vehicle manufacturer logo or the like, or may comprise a personalized or customized icon or logo or illumination at the side of the vehicle, such as by utilizing aspects of the systems and assemblies described in U.S. Pat. Nos. 7,255,451 and/or 7,289,037; and/or U.S. patent application Ser. No. 11/912,576, filed Oct. 25, 2007 (Attorney Docket DON01 P-1274), which are hereby incorporated herein by reference in their entireties. Optionally, the illumination source or module may illuminate the handle region of the door, and may provide ground illumination of the area by the vehicle, similar to safety illumination sources such as the types described in U.S. Pat. Nos. 5,371,659, 5,669,699, 5,823,654 and 5,497,305, which are hereby incorporated herein by reference in their entireties. When activated, the illumination source preferably draws a low or minimal amount of energy from a power source, such as a vehicle battery (not shown) or the like, such that the battery or power source is not overly drained during the period of time that the illumination source is activated,

Optionally, the door handle assembly or mirror assembly or illumination module may include or may be associated with an antenna for receiving signals from or communicating with a remote device. For example, the antenna (such as, for example, an antenna of the types described in U.S. Pat. No. 6,977,619, which is hereby incorporated herein by reference in its entirety) may communicate a signal to the door locking system via a wire connection or the like, or wirelessly, such as via a radio frequency signal or via an infrared signal or via other wireless signaling means. Such connections can include cables, wires, fiber optic cables or the like. The communication to the locking system may be via a vehicle bus or multiplex system, such as a LIN (Local Interconnect Network) or CAN (Car or Controlled Area Network) system, such as described in U.S. Pat. Nos. 6,291,905; 6,396,408; and/or 6,477,464, which are hereby incorporated herein by reference in their entireties. The vehicle door may then be unlocked and/or the illumination source or sources may be activated as a person carrying a remote signaling device approaches the door handle. Optionally, other systems may be activated in response to the remote signaling device, such as vehicle lighting systems, such as interior lights, security lights or the like (such as security lights of the types disclosed in U.S. Pat. Nos. 6,280,069; 6,276,821; 6,176,602; 6,152,590; 6,149,287; 6,139,172; 6,086,229; 5,938,321; 5,671,996; 5,497,305; 6,416,208; and/or 6,568,839, all of which are hereby incorporated herein by reference in their entireties), or the vehicle ignition, or any other desired system, while remaining within the spirit and scope of the present invention.

Changes and modifications to the specifically described embodiments may be carried out without departing from the principles of the present invention, which is intended to be limited only by the scope of the appended claims as interpreted according to the principles of patent law.

1. A handle/liftgate assembly for a door of a vehicle, said door handle assembly being mounted to a handle region of a vehicle door, said handle/liftgate assembly comprising:
a handle control;
a handle sensor; and
wherein said handle control is responsive to said handle sensor to detect the presence of or proximity of a user or operator at the vehicle door, and wherein said handle control actuates a door latch of the vehicle door to open the vehicle door independent of a door zone module or passive entry system of the vehicle door.

2. The handle/liftgate assembly of claim 1, wherein said handle sensor at least one of (a) detects movement of a handle portion of said handle/liftgate assembly and (b) detects the presence of a passive entry device or transmitting device carried by a user or operator of the vehicle.

3. The handle/liftgate assembly of claim 1, wherein said handle control communicates a signal to a vehicle or body control module, which determines whether or not the person detected at the vehicle door is recognized or authorized for entry into the vehicle, and wherein said body control module authenticates the detection of the presence of or proximity of the user by the handle control and unlocks the latch, whereby said handle control actuates the latch to open the vehicle door.

4. The handle/liftgate assembly of claim 3 comprising a base portion mountable to a vehicle door and a handle portion movably mountable to the vehicle door and movable relative to said base portion to actuate the latch to open the door.

5. The handle/liftgate assembly of claim 4, wherein said handle sensor comprises first and second microswitches that detect movement of said handle portion by a person at the vehicle door, wherein said handle control communicates a signal to a body control module of the vehicle in response to said first microswitch detecting an initial movement of said handle portion, and wherein said handle control actuates the latch to open the vehicle door in response to said second microswitch detecting a further movement of said handle portion.

6. The handle/liftgate assembly of claim 5 further comprising a passive entry device, said handle control being responsive to said passive entry device, which authenticates that the detected person is recognized or authorized for entry into the vehicle.

7. The handle/liftgate assembly of claim 1, wherein said handle assembly comprises a self-sustaining module or unit mountable at the vehicle door.

8. The handle/liftgate assembly of claim 1 further comprising an illumination module for illuminating at least one of a portion of the vehicle door, a portion of the handle, and a portion of the ground at the side of the vehicle.

9. The handle/liftgate assembly of claim 8, wherein said handle control is operable to control said illumination module, and wherein said handle control is programmable to selectively control said illumination module to provide at least one of (a) different lighting effects, (b) different colors of illumination and (c) ramped up and down illumination intensities.

10. The handle/liftgate assembly of claim 1, wherein said handle/liftgate assembly comprises one of (a) a strap handle assembly for opening a side door of a vehicle, (b) a paddle handle assembly for opening a side door of a vehicle, (c) a fixed handle assembly for opening a side door of a vehicle, (d) a liftgate handle assembly for opening a liftgate of a vehicle and (e) a fixed liftgate handle assembly for opening a liftgate of a vehicle.

11. The handle/liftgate assembly of claim 1, wherein at least one of (a) said handle control communicates with a passive entry system of the vehicle and (b) passive entry circuitry is incorporated in said handle control.
